(19) United States
(12) Patent Application Publication
(10) Pub. No.: US 2024/0192469 A1
(43) Pub. Date: Jun. 13, 2024

(54) OPTICAL IMAGING SYSTEM

(71) Applicant: SAMSUNG ELECTRO-MECHANICS CO., LTD., Suwon-si (KR)

(72) Inventors: You Jin JEONG, Suwon-si (KR); Jae Hyuk HUH, Suwon-si (KR)

(73) Assignee: SAMSUNG ELECTRO-MECHANICS CO., LTD., Suwon-si (KR)

(21) Appl. No.: 18/319,892

(22) Filed: May 18, 2023

(30) Foreign Application Priority Data
Dec. 9, 2022 (KR) 10-2022-0171754

(51) Int. Cl. G02B 13/00; G02B 9/62

(52) U.S. Cl. CPC G02B 13/0045; G02B 9/62

(57) ABSTRACT

An optical imaging system is provided. The optical imaging system includes a first lens group, a reflective member, and a second lens group arranged sequentially along an optical axis, and the first lens group may include one lens, and the second lens group includes two or more lenses, the first lens group may have positive refractive power, and the second lens group may have positive refractive power as a whole, an effective diameter of the lens included in the first lens group may be greater than an effective diameter of the lenses included in the second lens group, and 0<D1/f<0.05 may be satisfied. Here, D1 is a distance on the optical axis between an image-side surface of the lens included in the first lens group and the reflective member, and f is a total focal length of the optical imaging system.

### CROSS-REFERENCE TO RELATED APPLICATIONS

This application claims the benefit under 35 USC § 119(a) of Korean Patent Application No. 10-2022-0171754 filed on Dec. 9, 2022, in the Korean Intellectual Property Office, the entire disclosure of which is incorporated herein by reference for all purposes.

### BACKGROUND

### 1. Field

The following description relates to an optical imaging system.

### 2. Description of the Background

Portable terminals have recently included a camera including an optical imaging system comprising a plurality of lenses to enable video calls and image capturing operations.

Additionally, with a gradual increase in the operations of cameras in portable terminals, the demand for cameras for portable terminals having high resolution has increased.

In particular, recently, an image sensor with high pixels (e.g., 13 million to 100 million pixels) has been implemented in cameras for portable terminals in order to achieve clearer image quality.

Additionally, as the form factor of portable terminals has decreased, miniaturized cameras for portable terminals are also desired. Accordingly, the development of an optical imaging system that achieves high resolution while being slim is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical imaging system includes a first lens group, a reflective member, and a second lens group arranged sequentially along an optical axis, wherein the first lens group comprises one lens, and the second lens group comprises two or more lenses, wherein the first lens group has positive refractive power, and the second lens group has positive refractive power as a whole, wherein an effective diameter of the lens included in the first lens group is greater than an effective diameter of the lenses included in the second lens group, and wherein 0<D1/f<0.05 is satisfied, where D1 is a distance on the optical axis between an image-side surface of the lens included in the first lens group and the reflective member, and f is a total focal length of the optical imaging system.

TTL/f>1 may be satisfied, where TTL is a distance on the optical axis from an object-side surface of the lens included in the first lens group to an imaging surface.

1.5<TTL/BFL<3.5 may be satisfied, where BFL is a distance on the optical axis from an image-side surface of a rearmost lens among the lenses included in the second lens group to the imaging surface.

The first lens group may include a first lens, and the second lens group may include a second lens, a third lens, a fourth lens, and a fifth lens, and v1>50 m satisfied, where v1 is an Abbe number of the first lens.

An Abbe number of the second lens may be less than an Abbe number of the first lens.

10<v1−v2<60 may be satisfied, where v2 is an Abbe number of the second lens.

0.2<f/f1<1 may be satisfied, where f1 is a focal length of the first lens.

1.5<|f2/f3|<100 may be satisfied, where f2 is a focal length of the second lens, and f3 is a focal length of the third lens.

−65<fG2/f3<−3 may be satisfied, where fG2 is a focal length of the second lens group, and f3 is a focal length of the third lens.

0<fG1/fG2<3 may be satisfied, where fG1 is a focal length of the first lens group, and fG2 is a focal length of the second lens group.

Among the lenses included in the second lens group, one or more lenses may have negative refractive power and may have a concave object side and a concave image side.

Among the lenses included in the second lens group, when two or more lenses have negative refractive power and are concave on both sides, a lens with a smallest absolute value of a focal length among the lenses on which both sides are concave may have a refractive index of 1.62 or more, and an Abbe number of less than 26.

The second lens group comprises a second lens, a third lens, a fourth lens, and a fifth lens, and the first lens may have positive refractive power, the second lens may have positive refractive power, and the third lens may have negative refractive power.

The first lens group may include a first lens, and the second lens group comprises a second lens, a third lens, a fourth lens, a fifth lens, and a sixth lens, and the first lens may have positive refractive power, the third lens may have negative refractive power, and the fourth lens may have positive refractive power.

In a general aspect, an optical imaging system includes a first lens group, a reflective member, and a second lens group arranged sequentially along an optical axis, wherein the second lens group comprises four to five lenses, wherein the first lens group has positive refractive power, wherein a first lens of the first lens group has a concave image-side surface, wherein a second lens of the second lens group has negative refractive power, and wherein an effective diameter of the first lens included in the first lens group is greater than an effective diameter of the lenses included in the second lens group.

Other features and aspects will be apparent from the following detailed description, the drawings, and the claims.

### BRIEF DESCRIPTION OF DRAWINGS

FIG. 1 illustrates a structural view of an example optical imaging system, in accordance with one or more embodiments.

FIG. 2 is a view illustrating aberration characteristics of the example optical imaging system illustrated in FIG. 1.

FIG. 3 illustrates a structural view of an example optical imaging system, in accordance with one or more embodiments.

FIG. 4 is a view illustrating aberration characteristics of the example optical imaging system illustrated in FIG. 3.

FIG. 5 illustrates a structural view of an example optical imaging system, in accordance with one or more embodiments.

FIG. 6 is a view illustrating aberration characteristics of the example optical imaging system illustrated in FIG. 5.

FIG. 7 illustrates a structural view of an example optical imaging system, in accordance with one or more embodiments.

FIG. 8 is a view illustrating aberration characteristics of the example optical imaging system illustrated in FIG. 7.

FIG. 9 illustrates a structural view of an example optical imaging system, in accordance with one or more embodiments.

FIG. 10 is a structural view illustrating aberration characteristics of the example optical imaging system illustrated in FIG. 9.

FIG. 11 illustrates a structural view of an example optical imaging system, in accordance with one or more embodiments.

FIG. 12 is a view illustrating aberration characteristics of the example optical imaging system illustrated in FIG. 11.

FIG. 13 illustrates a structural view of an example optical imaging system, in accordance with one or more embodiments.

FIG. 14 is a view illustrating aberration characteristics of the example optical imaging system illustrated in FIG. 13.

FIG. 15 illustrates a structural view of an example optical imaging system, in accordance with one or more embodiments.

FIG. 16 is a view illustrating aberration characteristics of the example optical imaging system illustrated in FIG. 15.

FIG. 17 illustrates a structural view of an example optical imaging system, in accordance with one or more embodiments.

FIG. 18 is a view illustrating aberration characteristics of the example optical imaging system illustrated in FIG. 17.

FIG. 19 illustrates a structural view of an example optical imaging system, in accordance with one or more embodiments.

FIG. 20 is a view illustrating aberration characteristics of the example optical imaging system shown in FIG. 19.

FIG. 21 is a view of the example optical imaging system illustrated in FIG. 1 when viewed from another angle.

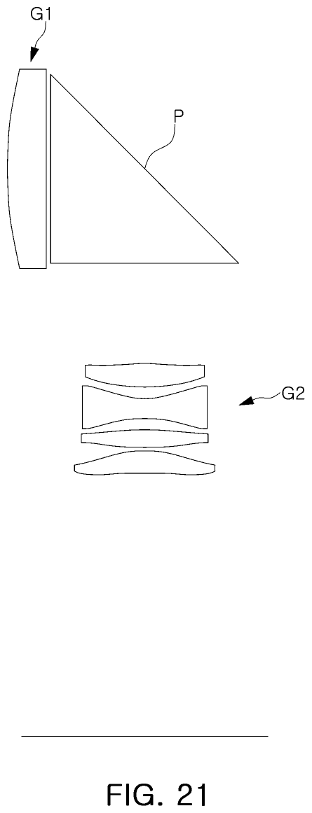

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of this disclosure, with the exception of operations necessarily occurring in a certain order. Also, descriptions of features that are known after an understanding of this disclosure may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of this disclosure.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

One or more examples provide an optical imaging system having a small size which can realize high resolution.

In the following lens structural view, the thickness, size, and shape of the lens are somewhat exaggerated for description, and specifically, the shape of a spherical or non-spherical surface presented in the lens structural view is only presented as an example, but the one or more examples are not limited thereto.

The optical imaging system, in accordance with one or more examples, may be mounted on a portable electronic device. As a non-limited example, the optical imaging system may be a component of a camera module mounted on a portable electronic device. The portable electronic device may be a portable electronic device such as a mobile communication terminal, a smartphone, or a tablet personal computer (PC).

In the one or more examples, a first lens (or a forwardmost lens) refers to the lens closest to an object side, and a last lens (or a rearmost lens) refers to the lens closest to an imaging surface (or an image sensor).

Additionally, in each lens, a first surface denotes a surface close to the object side (or an object-side surface), and a second surface denotes a surface close to an image side (or an image-side surface). Additionally, in the one or more examples, the values of the radius of curvature, thickness, distance, and focal length of the lens are all in mm units, and the unit of a field of view (FOV) is degrees.

Additionally, in the description of the shape of each lens, the disclosure that one surface is convex denotes that a paraxial region portion of the corresponding surface is convex, and the disclosure that one surface is concave denotes that the paraxial region portion of the corresponding surface is concave.

In an example, the paraxial region refers to a very narrow area near an optical axis.

The imaging surface may refer to a virtual surface on which a focus is formed by the optical imaging system. Alternatively, the imaging surface may refer to one surface of an image sensor on which light is received.

The optical imaging system, in accordance with one or more embodiments, includes a plurality of lens groups. For example, the optical imaging system may include a first lens group and a second lens group.

Each of the first lens group and the second lens group includes at least one lens. For example, the first lens group may include one lens, and the second lens group may include four or more lenses. Accordingly, the optical imaging system includes at least five lenses. Each lens is spaced apart from others thereof by a predetermined distance.

In an example embodiment, the optical imaging system includes a first lens, a second lens, a third lens, a fourth lens, a fifth lens, and a sixth lens arranged in order from an object side to an imaging side.

In an example embodiment, the optical imaging system includes a first lens, a second lens, a third lens, a fourth lens, and a fifth lens arranged in order from the object side to the imaging side.

The optical imaging system, in accordance with one or more embodiments, may further include a reflective member having a reflective surface that changes an optical path. In an example, the reflective member may be a mirror or a prism.

By bending the optical path through the reflective member, the optical path may be elongated in a relatively narrow space.

Accordingly, while miniaturizing the optical imaging system, the optical imaging system may have a long focal length.

The reflective member may be disposed between the first lens group and the second lens group. In an example, the reflective member may be disposed between the first lens and the second lens.

The optical imaging system may further include an image sensor that converts an image of an incident subject into an electrical signal.

Additionally, the optical imaging system may further include an infrared blocking filter (hereinafter, referred to as a ‘filter’) that blocks infrared rays. The filter may be disposed between the reflective member and the imaging surface.

Additionally, the optical imaging system may further include an aperture that adjusts an amount of light.

Some of the lenses among a plurality of lenses may be made of glass, and the other lenses may be made of plastic. In a non-limiting example, the first lens may be made of glass, and the remaining lenses may be made of plastic.

Some of the lenses among the plurality of lenses have at least one aspherical surface.

In an example, the first and second surfaces of the first lens included in the first lens group may be spherical, and at least one of the first and second surfaces of the lenses included in the second lens group may be aspherical. Here, the aspherical surface of each lens is expressed by Equation 1 below.

### Equation 1:

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} - {EY}^{12} + {FY}^{14} + {GY}^{16} + {HY}^{18} + {JY}^{20} …$$

In Equation 1, c is a curvature of the lens (i.e., an inverse number of the curvature radius), K is a cone constant, and Y is a distance from any point on the aspherical surface of the lens to the optical axis. Additionally, constants A to J refer to an aspherical coefficient. Furthermore, Z (SAG) represents a distance in an optical axis direction between vertices of the aspherical surface of the lens from any point on the aspherical surface of the lens.

The example optical imaging system, in accordance with one or more embodiments, may satisfy at least one of the following conditional equations.

TTL/f>1 [Conditional Expression 1]

v1>50 [Conditional Expression 2]

10<v1−v2<60 [Conditional Expression 3]

0.2<f/f1<1 [Conditional Expression 4]

1.5<|f2/f3|<100 [Conditional Expression 5]

−65<fG2/f3<−3 [Conditional Expression 6]

0<fG1/fG2<3 [Conditional Expression 7]

0<D1/f<0.05 [Conditional Expression 8]

1.5<TTL/BFL<3.5 [Conditional Expression 9]

In the conditional equations, f is a total focal length of the optical imaging system, f1 is a focal length of the first lens, f2 is a focal length of the second lens, f3 is a focal length of the third lens, fG1 is a focal length of the first lens group, and fG2 is a focal length of the second lens group.

TTL is a distance on the optical axis from an object-side surface of the first lens to the imaging surface, and D1 is a distance on the optical axis between an image-side surface of the first lens and the reflective member.

In an example, v1 is an Abbe number of the first lens, and v2 is an Abbe number of the second lens.

The first lens group has positive refractive power as a whole. Additionally, light passing through the first lens group disposed in front of the reflective member may be refracted to converge and is incident on the reflective member.

In accordance with one or more embodiments, the first lens group may include one lens (e.g., a first lens). The first lens may have a meniscus shape, convex toward the object side.

The second lens group includes a plurality of lenses and has positive refractive power as a whole.

In accordance with one or more embodiments, the second lens group includes a second lens, a third lens, a fourth lens, a fifth lens, and a sixth lens. At least one of the second to sixth lenses is concave on both sides.

In accordance with one or more embodiments, the second lens group includes a second lens, a third lens, a fourth lens, and a fifth lens. At least one of the second to fifth lenses is concave on both sides.

Additionally, the lens having a concave shape on both sides may be a high refractive lens. For example, among the lenses included in the second lens group, the lens having a concave shape on both sides may have a refractive index of 1.62 or more, and an Abbe number thereof may be less than 26.

When two or more of the lenses included in the second lens group have a concave shape on both sides, a lens with the smallest absolute value of the focal length among the corresponding lenses may be a high refractive lens.

For example, the third lens is concave on both sides and has negative refractive power. The third lens may have a refractive index of 1.62 or more, and an Abbe number thereof may be less than 26.

Additionally, the first lens and the second lens may be formed of materials having different optical characteristics. For example, the first lens may be formed of a material having a high Abbe number, and the second lens may be formed of a material having a smaller Abbe number than the first lens. Accordingly, chromatic aberration correction performance may be improved.

An effective radius of the first lens may be greater than effective radiuses of the other lenses. That is, the effective radius of the first lens may be the largest among the lenses included in the imaging optical system.

The imaging optical system, in accordance with one or more embodiments, may have the characteristics of a telephoto lens having a relatively narrow field of view (FOV) and a long focal length.

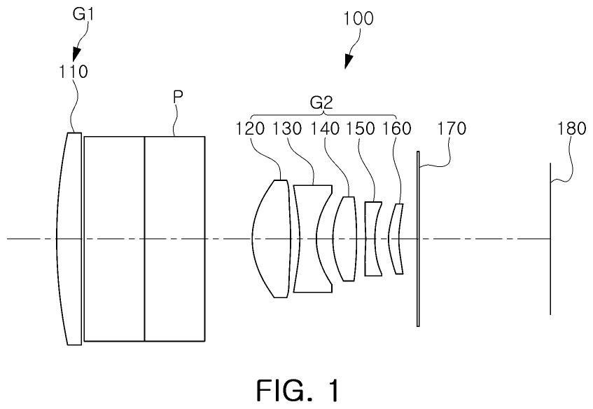

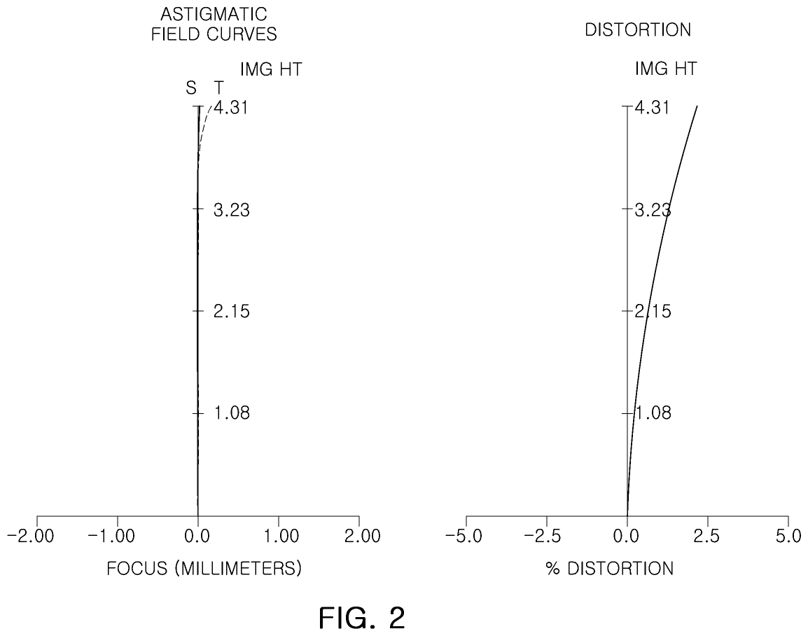

An optical imaging system 100, in accordance with one or more embodiments, will be described with reference to FIGS. 1 and 2.

Referring to FIG. 1, the example optical imaging system 100, in accordance with one or more embodiments, includes a first lens group G1, a reflective member P, and a second lens group G2.

The first lens group G1 includes a first lens 110, and the second lens group G2 includes a second lens 120, a third lens 130, a fourth lens 140, a fifth lens 150, and a sixth lens 160.

Additionally, the optical imaging system 100 may further include a filter 170 and an image sensor.

The example optical imaging system 100, in accordance with one or more embodiments, may form a focus on an imaging surface 180. The imaging surface 180 may denote a surface on which a focus is formed by the optical imaging system. In an example, the imaging surface 180 may denote one surface of an image sensor on which light is received.

The reflective member P may be disposed between the first lens 110 and the second lens 120 and may have a reflective surface that changes the optical path. In an example, the reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 1.

TABLE 1

| | | | Thickness | | | |
|---|---|---|---|---|---|---|
| Surface | | | or | | Abbe | Focal |
| Number | Division | Radius | Distance | Index | Number | Length |
| S1 | First Lens | 31.000 | 1.350 | 1.498 | 81.6 | 62.2351 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 2.100 | | | |
| S6 | Second Lens | 4.953 | 2.100 | 1.537 | 55.7 | 7.2237 |
| S7 | | −15.192 | 0.500 | | | |
| S8 | Third Lens | −7.450 | 0.900 | 1.646 | 23.5 | −3.8513 |
| S9 | | 3.894 | 0.900 | | | |
| S10 | Fourth Lens | 4.685 | 1.300 | 1.677 | 19.2 | 5.1373 |
| S11 | | −11.986 | 0.500 | | | |
| S12 | Fifth Lens | −9.902 | 0.500 | 1.646 | 23.5 | −6.1257 |
| S13 | | 6.688 | 0.744 | | | |
| S14 | Sixth Lens | 3.229 | 0.569 | 1.546 | 56.0 | 14.0578 |
| S15 | | 5.230 | 1.000 | | | |
| S16 | Filter | Infinity | 0.110 | 1.519 | 64.2 | |
| S17 | | Infinity | 7.176 | | | |
| S18 | Imaging | Infinity | | | | |
| | Surface | | | | | |

In an example, the total focal length f of the example optical imaging system 100, in accordance with one or more embodiments, is 18 mm, and the focal length fG2 of the second lens group G2 is 23.9679 mm.

Referring to FIG. 1, in the first embodiment, the first lens 110 has positive refractive power, a first surface of the first lens 110 is convex, and a second surface of the first lens 110 is concave.

The second lens 120 has positive refractive power, and first and second surfaces of the second lens 120 are convex.

The third lens 130 has negative refractive power, and first and second surfaces of the third lens 130 are concave.

The fourth lens 140 has positive refractive power, and first and second surfaces of the fourth lens 140 are convex.

The fifth lens 150 has negative refractive power, and first and second surfaces of the fifth lens 150 are concave.

The sixth lens 160 has positive refractive power, a first surface of the sixth lens 160 is convex, and a second surface of the sixth lens 160 is concave.

In an example, each surface of the second lens 120 to the sixth lens 160 has an aspherical coefficient as illustrated in Table 2. For example, the object-side surfaces and the image-side surfaces of the second lens 120 to the sixth lens 160 are aspherical.

TABLE 2

| | S6 | S7 | S8 | S9 | S10 |
|---|---|---|---|---|---|
| Conic Constant (K) | −0.512 | −99.000 | −27.076 | −2.652 | −2.838 |
| Fourth Coefficient | 3.8136E−04 | 2.4478E−03 | 1.3353E−03 | 7.3345E−04 | −1.2053E−03 |
| (A) | | | | | |
| Sixth Coefficient | 5.9212E−06 | −2.0981E−04 | −5.1804E−05 | 3.7687E−04 | 2.0230E−04 |
| (B) | | | | | |
| Eighth Coefficient | 2.4063E−07 | 2.7577E−06 | −1.2746E−05 | −1.7866E−05 | 1.3507E−05 |
| (C) | | | | | |
| Tenth Coefficient | −1.8887E−07 | 2.6860E−08 | 1.8311E−07 | −3.0088E−06 | −1.6033E−06 |
| (D) | | | | | |
| Twelfth Coefficient | −1.0249E−08 | −6.4903E−08 | 1.1007E−07 | −4.2511E−07 | 1.3187E−06 |
| (E) | | | | | |
| Fourteenth | 1.2882E−09 | 9.8369E−10 | −3.2632E−09 | 1.8682E−07 | 9.5047E−09 |
| Coefficient (F) | | | | | |
| Sixteenth | −3.8455E−11 | 3.9692E−10 | −3.9727E−10 | 1.4187E−08 | −2.8710E−08 |
| Coefficient (G) | | | | | |
| Eighteenth | −1.2321E−11 | −8.2799E−12 | 4.4566E−11 | −8.1175E−09 | 7.3447E−10 |
| Coefficient (H) | | | | | |
| Twentieth | 1.1555E−13 | −7.3767E−13 | −1.5206E−12 | 5.8787E−10 | −1.5502E−11 |
| Coefficient (J) | | | | | |
| | S11 | S12 | S13 | S14 | S15 |
| Conic Constant (K) | −98.960 | −99.000 | 5.123 | −5.078 | −5.786 |
| Fourth Coefficient | 9.5119E−04 | 9.6293E−03 | −2.7817E−03 | −1.0944E−02 | −1.0252E−02 |
| (A) | | | | | |
| Sixth Coefficient | −3.8284E−04 | −5.5346E−04 | 1.6919E−03 | 1.0503E−03 | −3.2550E−04 |
| (B) | | | | | |
| Eighth Coefficient | 4.3161E−05 | −1.0333E−04 | 1.7264E−03 | 4.3224E−04 | 6.5295E−04 |
| (C) | | | | | |
| Tenth Coefficient | 3.6947E−06 | −3.3247E−06 | −2.2204E−03 | −1.3095E−04 | −1.2920E−04 |
| (D) | | | | | |
| Twelfth Coefficient | 2.1545E−07 | 1.4110E−06 | 1.3467E−03 | 1.9129E−05 | 9.2437E−08 |
| (E) | | | | | |
| Fourteenth | 6.4572E−08 | 2.1940E−07 | −5.0966E−04 | −1.4863E−06 | 3.8819E−06 |
| Coefficient (F) | | | | | |
| Sixteenth | −1.1967E−08 | −3.5316E−08 | 1.1821E−04 | 4.2886E−08 | −2.2731E−07 |
| Coefficient (G) | | | | | |
| Eighteenth | −1.0932E−08 | −3.6256E−08 | −1.5329E−05 | 2.3409E−08 | −7.8189E−08 |
| Coefficient (H) | | | | | |
| Twentieth | 1.1821E−09 | 5.5808E−09 | 8.5147E−07 | −2.5995E−09 | 1.0152E−08 |
| Coefficient (J) | | | | | |

Additionally, the example optical imaging system configured as described above may have the aberration characteristics illustrated in FIG. 2.

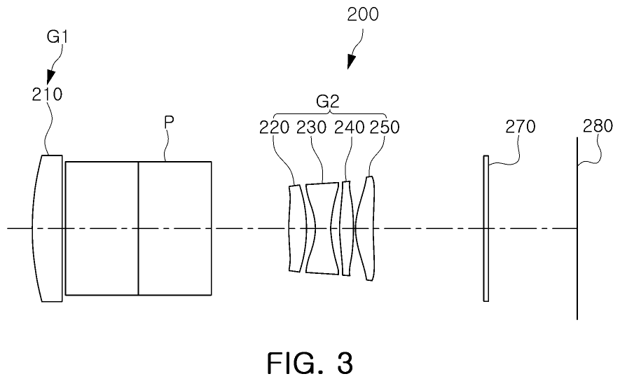

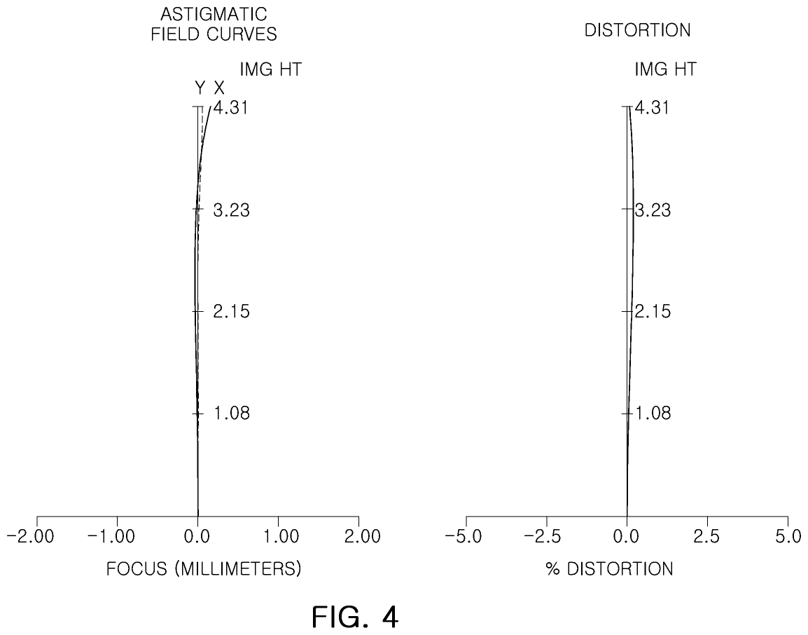

An example optical imaging system 200, in accordance with one or more embodiments, will be described with reference to FIGS. 3 and 4.

Referring to FIG. 3, the optical imaging system 200, in accordance with one or more embodiments, includes a first lens group G1, a reflective member P, and a second lens group G2.

The first lens group G1 includes a first lens 210, and the second lens group G2 includes a second lens 220, a third lens 230, a fourth lens 240, and a fifth lens 250.

Additionally, the example optical imaging system 200 may further include a filter 270 and an image sensor including an imaging surface 280.

The optical imaging system 200, in accordance with one or more embodiments, may form a focus on an imaging surface 280. The imaging surface 280 may refer to a surface on which a focus is formed by the optical imaging system. In an example, the imaging surface 280 may refer to one surface of the image sensor on which light is received.

The reflective member P may be disposed between the first lens 210 and the second lens 220 and may have a reflective surface that changes the optical path. The reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 3 below.

TABLE 3

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | 10.401 | 0.800 | 1.646 | 23.5 | 6.8076 |
| | Lens | | | | | |
| S7 | | −7.381 | 0.400 | | | |
| S8 | Third Lens | −2.647 | 0.700 | 1.646 | 23.5 | −2.2697 |
| S9 | | 3.622 | 0.400 | | | |
| S10 | Fourth Lens | 6.686 | 0.618 | 1.620 | 25.9 | 7.4660 |
| S11 | | −14.516 | 0.100 | | | |
| S12 | Fifth Lens | 3.174 | 0.800 | 1.546 | 56.0 | 6.8099 |
| S13 | | 19.671 | 5.000 | | | |
| S14 | Filter | Infinity | 0.210 | 1.519 | 64.2 | |
| S15 | | Infinity | 4.015 | | | |
| S16 | Imaging | Infinity | | | | |
| | Surface | | | | | |

In an example, the total focal length f of the example optical imaging system 200 according to the second embodiment is 14.08 mm, and the focal length fG2 of the second lens group G2 is 16.3946 mm.

Referring to FIG. 2, in the second embodiment, the first lens 210 has positive refractive power, the first surface of the first lens 210 is convex, and the second surface of the first lens 210 is concave.

The second lens 220 has positive refractive power, and first and second surfaces of the second lens 220 are convex.

The third lens 230 has negative refractive power, and first and second surfaces of the third lens 230 are concave.

The fourth lens 240 has positive refractive power, and first and second surfaces of the fourth lens 240 are convex.

The fifth lens 250 has positive refractive power, a first surface of the fifth lens 250 is convex, and a second surface of the fifth lens 250 is concave.

In an example, each surface of the second lens 220 to the fifth lens 250 has an aspherical coefficient as illustrated in Table 4. In an example, the object-side surfaces and the image-side surfaces of the second lens 220 to the fifth lens 250 are aspherical.

TABLE 4

| | S6 | S7 | S8 | S9 |
|---|---|---|---|---|
| Conic Constant (K) | 14.626 | −60.802 | −3.729 | −20.813 |
| Fourth Coefficient (A) | −6.7305E−03 | −1.0382E−02 | 4.2670E−03 | −1.9675E−03 |
| Sixth Coefficient (B) | −2.4753E−03 | −1.1287E−03 | 9.2618E−04 | 2.8698E−03 |
| Eighth Coefficient (C) | 2.1786E−04 | 2.1716E−04 | 3.3390E−04 | −3.5124E−04 |
| Tenth Coefficient (D) | −1.1198E−04 | 8.3406E−05 | −6.2470E−05 | −1.6858E−05 |
| Twelfth Coefficient (E) | 1.6500E−05 | −8.2028E−06 | 6.7084E−06 | 7.8126E−06 |
| Fourteenth Coefficient (F) | 3.9068E−06 | −1.7876E−06 | −1.5256E−06 | −4.3345E−06 |
| Sixteenth Coefficient (G) | −6.2388E−07 | 3.2350E−07 | 1.2104E−07 | 4.0070E−07 |
| Eighteenth Coefficient (H) | −4.0403E−19 | −3.6501E−19 | 7.8494E−09 | −8.2880E−19 |
| Twentieth Coefficient (J) | −6.9194E−20 | −6.6281E−20 | −4.0829E−20 | −6.1591E−20 |
| | S10 | S11 | S12 | S13 |
| Conic Constant (K) | −45.551 | 24.561 | −5.920 | 53.086 |
| Fourth Coefficient (A) | −6.1629E−03 | −8.1247E−03 | −1.8390E−03 | 4.6278E−04 |
| Sixth Coefficient (B) | −1.1430E−04 | 1.3690E−03 | −6.9424E−04 | −2.3859E−03 |
| Eighth Coefficient (C) | 2.4945E−04 | 6.2151E−05 | 3.0667E−04 | 4.4531E−04 |
| Tenth Coefficient (D) | 4.0089E−05 | −1.1098E−05 | −7.8210E−05 | −5.1901E−05 |
| Twelfth Coefficient (E) | −5.2404E−06 | 7.3525E−07 | 2.3102E−06 | −2.4862E−06 |
| Fourteenth Coefficient (F) | −1.4888E−06 | 1.6634E−06 | 1.6036E−06 | 3.5669E−07 |
| Sixteenth Coefficient (G) | −6.1085E−09 | −1.4138E−07 | −3.0897E−07 | 1.5414E−07 |
| Eighteenth Coefficient (H) | −6.9836E−19 | −9.8536E−10 | 3.9670E−08 | −2.4852E−08 |
| Twentieth Coefficient (J) | −6.0908E−20 | −6.5340E−20 | −2.3635E−09 | 1.0629E−09 |

Additionally, the example optical imaging system configured as described above may have aberration characteristics illustrated in FIG. 4.

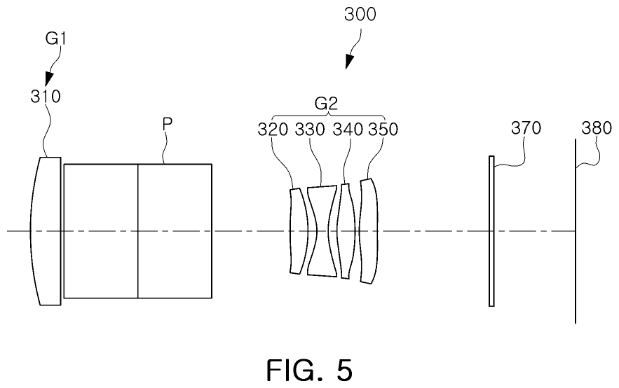

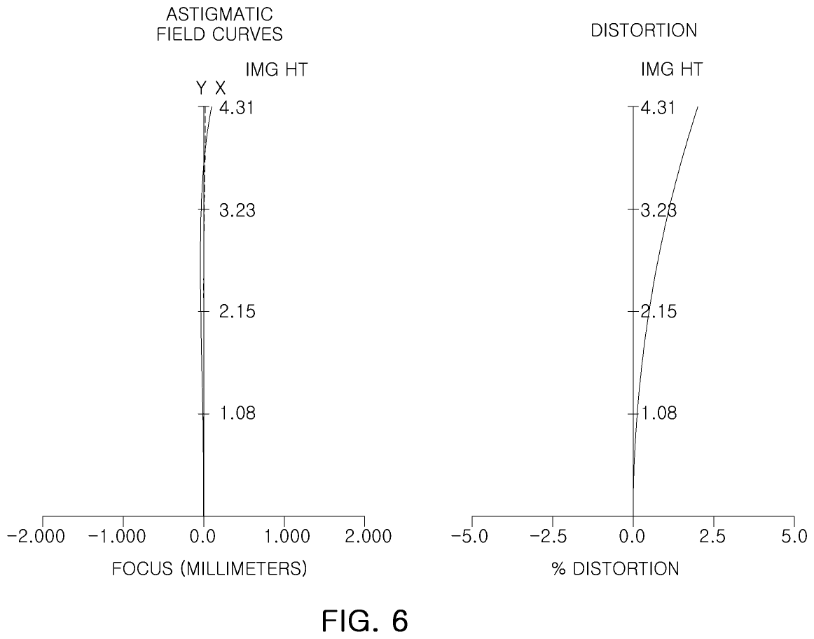

An example optical imaging system 300 according to a third embodiment will be described with reference to FIGS. 5 and 6.

Referring to FIG. 5, the example optical imaging system 300 according to the third embodiment includes a first lens group G1, a reflective member P, and a second lens group G2.

The first lens group G1 includes a first lens 310, and the second lens group G2 includes a second lens 320, a third lens 330, a fourth lens 340, and a fifth lens 350.

Additionally, the optical imaging system 300 may further include a filter 370 and an image sensor including an imaging surface 380.

The example optical imaging system 300 according to the third embodiment may form a focus on an imaging surface 380. The imaging surface 380 may refer to a surface on which a focus is formed by the optical imaging system. For example, the imaging surface 380 may refer to one surface of the image sensor on which light is received.

The reflective member P may be disposed between the first lens 310 and the second lens 320, and may have a reflective surface that changes the optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 5 below.

TABLE 5

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | 11.698 | 0.800 | 1.646 | 23.5 | 5.1522 |
| | Lens | | | | | |
| S7 | | −4.523 | 0.400 | | | |
| S8 | Third Lens | −2.417 | 0.501 | 1.620 | 25.9 | −2.0143 |
| S9 | | 3.169 | 0.400 | | | |
| S10 | Fourth Lens | 4.540 | 0.800 | 1.657 | 21.5 | 5.0520 |
| S11 | | −9.421 | 0.200 | | | |
| S12 | Fifth Lens | 5.768 | 0.800 | 1.546 | 56.0 | 11.6138 |
| S13 | | 60.301 | 5.000 | | | |
| S14 | Filter | Infinity | 0.210 | 1.519 | 64.2 | |
| S15 | | Infinity | 3.640 | | | |
| S16 | Imaging | Infinity | | | | |
| | Surface | | | | | |

In an example, the total focal length f of the optical imaging system 300 according to the third embodiment is 14.08 mm, and the focal length fG2 of the second lens group G2 is 11.0588 mm.

In the third embodiment, the first lens 310 has positive refractive power, a first surface of the first lens 310 is convex, and a second surface of the first lens 310 is concave.

The second lens 320 has positive refractive power, and first and second surfaces of the second lens 320 are convex.

The third lens 330 has negative refractive power, and first and second surfaces of the third lens 330 are concave.

The fourth lens 340 has positive refractive power, and first and second surfaces of the fourth lens 340 are convex.

The fifth lens 350 has positive refractive power, a first surface of the fifth lens 350 is convex, and a second surface of the fifth lens 350 is concave.

In an example, each surface of the second lens 320 to the fifth lens 350 has an aspherical coefficient as illustrated in Table 6 below. In an example, the object-side surfaces and the image-side surfaces of the second lens 320 to the fifth lens 350 are aspherical.

TABLE 6

| | S6 | S7 | S8 | S9 |
|---|---|---|---|---|
| Conic Constant (K) | 16.562 | −21.685 | −4.367 | −16.987 |
| Fourth Coefficient (A) | −7.3128E−03 | −9.8848E−03 | 3.4334E−03 | 8.0759E−04 |
| Sixth Coefficient (B) | −2.1756E−03 | −9.3186E−04 | 9.4818E−04 | 1.3805E−03 |
| Eighth Coefficient (C) | 3.2211E−05 | 2.6103E−04 | 4.4190E−04 | −2.6193E−04 |
| Tenth Coefficient (D) | −6.5663E−05 | 7.3622E−05 | −5.3887E−05 | −1.5853E−06 |
| Twelfth Coefficient (E) | 2.7468E−05 | −5.8501E−06 | −1.4926E−06 | 7.0451E−06 |
| Fourteenth Coefficient (F) | 2.2884E−06 | −2.2619E−07 | −7.4949E−07 | −2.9087E−06 |
| Sixteenth Coefficient (G) | −7.2425E−07 | 7.7670E−08 | 1.7552E−07 | 1.6152E−07 |
| Eighteenth Coefficient (H) | 1.8388E−21 | −1.0311E−20 | 2.1642E−21 | −1.1103E−20 |
| Twentieth Coefficient (J) | −7.7760E−23 | −2.5210E−22 | −9.2780E−23 | −3.0014E−22 |
| | S10 | S11 | S12 | S13 |
| Conic Constant (K) | −19.611 | 8.730 | −20.046 | 6.736 |
| Fourth Coefficient (A) | −4.6487E−03 | −6.8344E−03 | −1.3338E−02 | −7.3567E−03 |
| Sixth Coefficient (B) | −9.5917E−04 | 4.6678E−04 | −5.1479E−05 | −8.5413E−04 |
| Eighth Coefficient (C) | 6.8969E−07 | 1.7286E−05 | 3.7285E−04 | 2.3071E−04 |
| Tenth Coefficient (D) | 4.8400E−05 | 1.1157E−05 | −3.3570E−05 | −1.5001E−05 |
| Twelfth Coefficient (E) | 4.2270E−06 | 6.0745E−06 | −2.8973E−06 | −4.3580E−06 |
| Fourteenth Coefficient (F) | 3.0965E−07 | −2.9973E−07 | −4.7108E−07 | 4.0304E−07 |
| Sixteenth Coefficient (G) | −3.3828E−07 | 1.2541E−07 | 8.4946E−08 | 7.8348E−08 |
| Eighteenth Coefficient (H) | 9.1807E−21 | −9.8536E−10 | 2.8373E−08 | −1.5785E−08 |
| Twentieth Coefficient (J) | 1.0784E−22 | −7.2780E−22 | −2.9133E−09 | 9.7498E−10 |

Additionally, the optical imaging system configured as described above may have the aberration characteristics illustrated in FIG. 6.

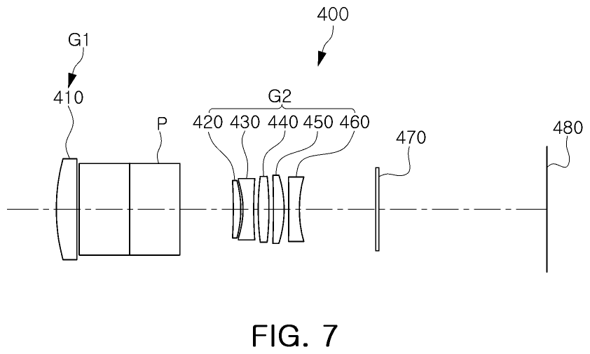

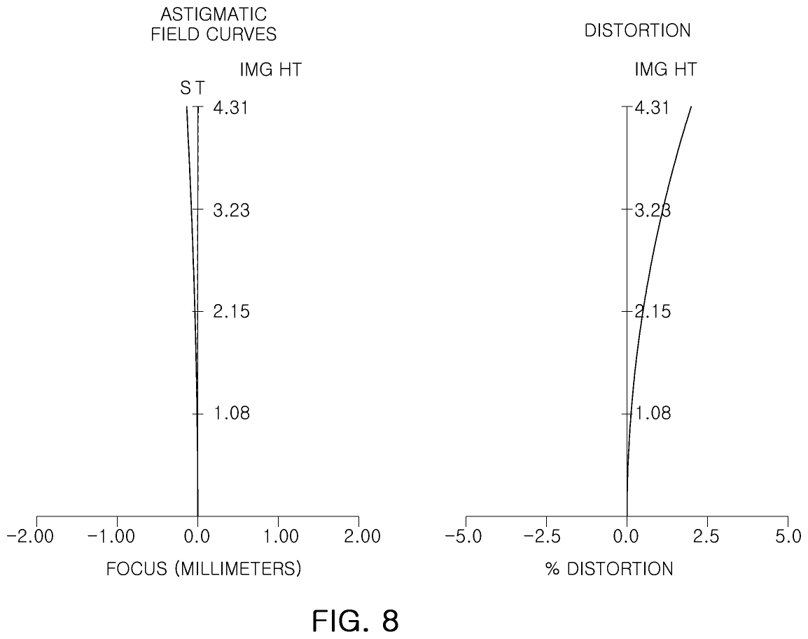

An example optical imaging system 400 according to a fourth embodiment will be described with reference to FIGS. 7 and 8.

Referring to FIG. 7, the optical imaging system 400 according to the fourth embodiment includes a first lens group G1, a reflective member P, and a second lens group G2.

The first lens group G1 includes a first lens 410, and the second lens group G2 includes a second lens 420, a third lens 430, a fourth lens 440, a fifth lens 450, and a sixth lens 460.

Additionally, the example optical imaging system 400 may further include a filter 470 and an image sensor.

The example optical imaging system 400 according to the fourth embodiment may form a focus on an imaging surface 480. The imaging surface 480 may refer to a surface on which a focus is formed by the optical imaging system. For example, the imaging surface 480 may refer to one surface of the image sensor on which light is received.

The reflective member P is disposed between the first lens 410 and the second lens 420 and may have a reflective surface that changes the optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 7 below.

TABLE 7

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | −47.766 | 0.486 | 1.546 | 56.0 | 15.9434 |
| | Lens | | | | | |
| S7 | | −7.393 | 0.149 | | | |
| S8 | Third | −6.276 | 0.700 | 1.646 | 23.5 | −8.0558 |
| S9 | Lens | 31.666 | 0.300 | | | |
| S10 | Fourth | 16.080 | 0.700 | 1.668 | 20.4 | 13.9578 |
| S11 | Lens | −21.829 | 0.300 | | | |
| S12 | Fifth Lens | −20.236 | 0.700 | 1.537 | 55.7 | 21.4987 |
| S13 | | −7.441 | 0.300 | | | |
| S14 | Sixth Lens | −265.060 | 0.700 | 1.537 | 55.7 | −16.5459 |
| S15 | | 9.204 | 5.000 | | | |
| S16 | Filter | Infinity | 0.210 | 1.519 | 64.2 | |
| S17 | | Infinity | 11.021 | | | |
| S18 | Imaging | Infinity | | | | |
| | Surface | | | | | |

In an example, the total focal length f of the optical imaging system 400 according to the fourth embodiment is 27 mm, and the focal length fG2 of the second lens group G2 is 522.2128 mm.

In the fourth embodiment, the first lens 410 has positive refractive power, a first surface of the first lens 410 is convex, and a second surface of the first lens 410 is concave.

The second lens 420 has positive refractive power, a first surface of the second lens 420 is concave, and a second surface of the second lens 420 is convex.

The third lens 430 has negative refractive power, and first and second surfaces of the third lens 430 are concave.

The fourth lens 440 has positive refractive power, and first and second surfaces of the fourth lens 440 are convex.

The fifth lens 450 has positive refractive power, a first surface of the fifth lens 450 is concave, and a second surface of the fifth lens 450 is convex.

The sixth lens 460 has negative refractive power, and first and second surfaces of the sixth lens 460 are concave.

In an example, each surface of the second lens 420 to the sixth lens 460 has an aspherical coefficient as illustrated in Table 8 below. For example, the object-side surfaces and the image-side surfaces of the second lens 420 to the sixth lens 460 are aspherical surfaces.

TABLE 8

| | S6 | S7 | S8 | S9 | S10 |
|---|---|---|---|---|---|
| Conic Constant (K) | 99.000 | −2.169 | −0.219 | −28.402 | −42.576 |
| Fourth Coefficient (A) | −4.8389E−04 | −6.4112E−05 | 4.2589E−04 | −1.3391E−04 | 1.7678E−04 |
| Sixth Coefficient (B) | −4.0871E−05 | 1.2820E−05 | 1.0530E−04 | 4.0836E−05 | −6.1213E−05 |
| Eighth Coefficient (C) | −1.0368E−05 | 1.8969E−05 | 2.5291E−05 | 2.0016E−06 | −4.0798E−06 |

| | S11 | S12 | S13 | S14 | S15 |
|---|---|---|---|---|---|
| Conic Constant (K) | 24.096 | −99.000 | 0.078 | 99.000 | 9.143 |
| Fourth Coefficient (A) | −9.5812E−05 | 4.2971E−04 | 2.0355E−04 | 5.9385E−05 | −5.3638E−05 |
| Sixth Coefficient (B) | 7.4053E−05 | 9.4078E−05 | 3.6697E−05 | 3.4169E−06 | −1.9780E−04 |
| Eighth Coefficient (C) | 2.2003E−06 | 4.0004E−05 | 2.2611E−05 | −1.4331E−05 | −1.8907E−05 |

Additionally, the example optical imaging system configured as described above may have the aberration characteristics illustrated in FIG. 8.

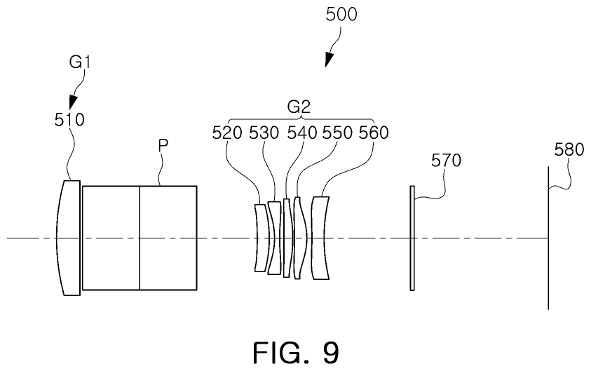

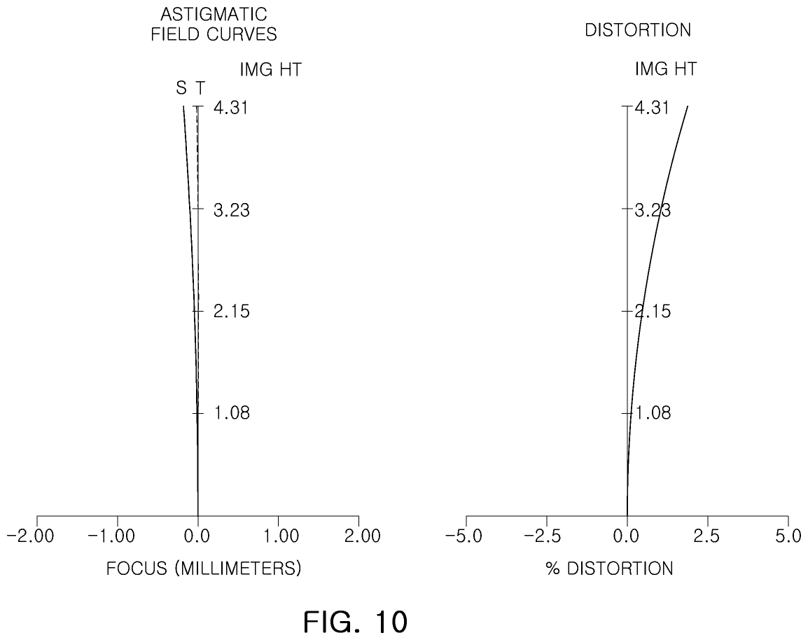

An example optical imaging system 500 according to a fifth embodiment will be described with reference to FIGS. 9 and 10.

Referring to FIG. 9. the example optical imaging system 500 according to the fifth embodiment includes a first lens group G1, a reflective member P, and a second lens group G2.

The first lens group G1 includes a first lens 510, and the second lens group G2 includes a second lens 520, a third lens 530, a fourth lens 540, a fifth lens 550, and a sixth lens 560.

Additionally, the example optical imaging system 500 may further include a filter 570 and an image sensor.

The optical imaging system 500 according to the fifth embodiment may form a focus on the imaging surface 580. The imaging surface 580 may refer to a surface on which a focus is formed by the optical imaging system. In an example, the imaging surface 580 may refer to one surface of the image sensor on which light is received.

The reflective member P may be disposed between the first lens 510 and the second lens 520, and may have a reflective surface that changes the optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 9 below.

TABLE 9

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | −28.783 | 0.700 | 1.546 | 56.0 | 18.7776 |
| | Lens | | | | | |
| S7 | | −7.628 | 0.300 | | | |
| S8 | Third Lens | −4.592 | 0.303 | 1.646 | 23.5 | −5.1993 |
| S9 | | 12.795 | 0.241 | | | |
| S10 | Fourth Lens | 72.026 | 0.523 | 1.668 | 20.4 | 10.0077 |
| S11 | | −7.352 | 0.100 | | | |
| S12 | Fifth Lens | −33.928 | 0.700 | 1.537 | 55.7 | 8.6906 |
| S13 | | −4.133 | 0.300 | | | |
| S14 | Sixth Lens | −27.474 | 0.700 | 1.537 | 55.7 | −14.5583 |
| S15 | | 11.029 | 5.000 | | | |
| S16 | Filter | Infinity | 0.210 | 1.519 | 64.2 | |
| S17 | | Infinity | 7.756 | | | |
| S18 | Imaging | Infinity | | | | |
| | Surface | | | | | |

In an example, the total focal length f of the optical imaging system 500 according to the fifth embodiment is 20 mm, and the focal length fG2 of the second lens group G2 is 39.1250 mm.

In the fifth embodiment, the first lens 510 has positive refractive power, a first surface of the first lens 510 is convex, and a second surface of the first lens 510 is concave.

The second lens 520 has positive refractive power, a first surface of the second lens 520 is concave, and a second surface of the second lens 520 is convex.

The third lens 530 has negative refractive power, and first and second surfaces of the third lens 530 are concave.

The fourth lens 540 has positive refractive power, and first and second surfaces of the fourth lens 540 are convex.

The fifth lens 550 has positive refractive power, a first surface of the fifth lens 550 is concave, and a second surface of the fifth lens 550 is convex.

The sixth lens 560 has negative refractive power, and first and second surfaces of the sixth lens 560 are concave.

In an example, each surface of the second lens 520 to the sixth lens 560 has an aspherical coefficient as illustrated in Table 10. In an example, the object-side surfaces and the image-side surfaces of the second lens 520 to the sixth lens 560 are aspherical.

TABLE 10

| | S6 | S7 | S8 | S9 | S10 |
|---|---|---|---|---|---|
| Conic Constant (K) | 99.000 | −2.500 | −1.563 | −67.210 | 47.121 |
| Fourth Coefficient (A) | −4.3615E−03 | −1.1227E−04 | 1.5875E−03 | −1.3397E−03 | −2.4868E−05 |
| Sixth Coefficient (B) | −2.4463E−04 | −2.1623E−04 | 3.1299E−04 | −5.7784E−04 | −6.4418E−06 |
| Eighth Coefficient (C) | −2.7802E−05 | 4.8925E−05 | 7.0984E−05 | −3.9093E−05 | −5.2901E−05 |
| | S11 | S12 | S13 | S14 | S15 |
| Conic Constant (K) | −11.792 | −15.376 | −2.218 | −99.000 | 11.748 |
| Fourth Coefficient (A) | 5.1355E−04 | 8.0023E−04 | 1.8689E−03 | 2.1494E−03 | −3.9514E−03 |
| Sixth Coefficient (B) | 3.6704E−04 | 4.0055E−04 | 5.2753E−04 | 4.1165E−04 | 3.6912E−04 |
| Eighth Coefficient (C) | 4.1205E−06 | 7.1302E−06 | 5.6905E−05 | 1.7157E−05 | 5.1464E−07 |

Additionally, the optical imaging system configured as described above may have the aberration characteristics illustrated in FIG. 10.

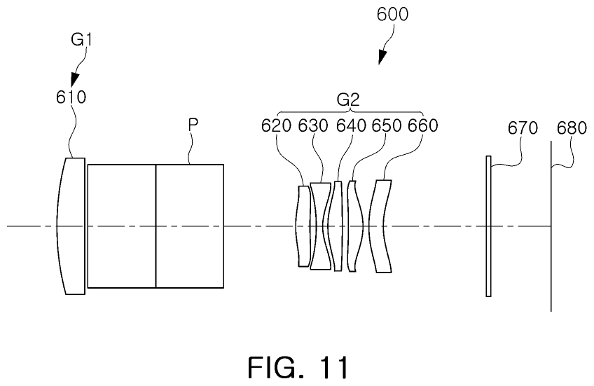

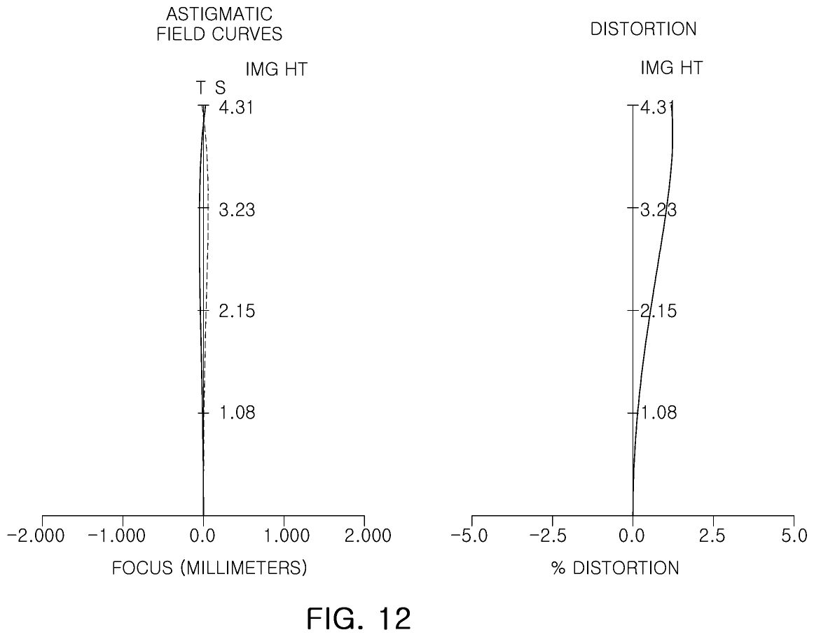

An example optical imaging system 600 according to a sixth embodiment will be described with reference to FIGS. 11 and 12.

The example optical imaging system 600 according to the sixth embodiment includes a first lens group G1, a reflective member P, and a second lens group G2.

The first lens group G1 includes a first lens 610, and the second lens group G2 includes a second lens 620, a third lens 630, a fourth lens 640, a fifth lens 650, and a sixth lens 660.

Additionally, the optical imaging system 600 may further include a filter 670 and an image sensor.

The example optical imaging system 600 according to the sixth embodiment may form a focus on an imaging surface 680. The imaging surface 680 may refer to a surface on which a focus is formed by the optical imaging system. In an example, the imaging surface 680 may refer to one surface of the image sensor on which light is received.

The reflective member P may be disposed between the first lens 610 and the second lens 620 and may have a reflective surface that changes the optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 11 below.

TABLE 11

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | 5.292 | 0.700 | 1.546 | 56.0 | 13.1271 |
| | Lens | | | | | |
| S7 | | 19.244 | 0.300 | | | |
| S8 | Third Lens | −7.634 | 0.309 | 1.646 | 23.5 | −2.9212 |
| S9 | | 2.544 | 0.254 | | | |
| S10 | Fourth Lens | 3.711 | 0.700 | 1.668 | 20.4 | 5.6102 |
| S11 | | 331.096 | 0.300 | | | |
| S12 | Fifth Lens | −31.022 | 0.700 | 1.537 | 55.7 | 7.1972 |
| S13 | | −3.465 | 0.300 | | | |
| S14 | Sixth Lens | 5.798 | 0.700 | 1.537 | 55.7 | −31.0997 |
| S15 | | 4.123 | 5.000 | | | |
| S16 | Filter | Infinity | 0.210 | 1.519 | 64.2 | |
| S17 | | Infinity | 2.929 | | | |
| S18 | Imaging | Infinity | | | | |
| | Surface | | | | | |

In an example, the total focal length f of the optical imaging system 600 according to the sixth embodiment is 14 mm, and the focal length fG2 of the second lens group G2 is 17.3773 mm.

In the sixth embodiment, the first lens 610 has positive refractive power, a first surface of the first lens 610 is convex, and a second surface of the first lens 610 is concave.

The second lens 620 has positive refractive power, a first surface of the second lens 620 is convex, and a second surface of the second lens 620 is concave.

The third lens 630 has negative refractive power, and first and second surfaces of the third lens 630 are concave.

The fourth lens 640 has positive refractive power, a first surface of the fourth lens 640 is convex, and a second surface of the fourth lens 640 is concave.

The fifth lens 650 has positive refractive power, a first surface of the fifth lens 650 is concave, and a second surface of the fifth lens 650 is convex.

The sixth lens 660 has negative refractive power, a first surface of the sixth lens 660 is convex, and a second surface of the sixth lens 660 is concave.

In an example, each surface of the second lens 620 to the sixth lens 660 has an aspherical coefficient as illustrated in Table 12 below. For example, the object-side surfaces and the image-side surfaces of the second lens 620 to the sixth lens 660 are aspherical.

TABLE 12

| | S6 | S7 | S8 | S9 | S10 |
|---|---|---|---|---|---|
| Conic Constant (K) | −13.055 | −72.069 | −0.492 | −7.428 | −12.748 |
| Fourth Coefficient (A) | −1.4106E−03 | −9.0264E−04 | 6.8293E−04 | −1.1256E−03 | 8.2364E−04 |
| Sixth Coefficient (B) | −1.6735E−03 | −1.5892E−03 | 5.3333E−04 | −8.2660E−04 | −1.5266E−04 |
| Eighth Coefficient (C) | −1.4749E−04 | −1.9363E−04 | −1.7892E−04 | −9.7231E−05 | −1.2789E−04 |

| | S11 | S12 | S13 | S14 | S15 |
|---|---|---|---|---|---|
| Conic Constant (K) | −99.000 | 91.947 | −3.048 | 0.164 | −7.982 |
| Fourth Coefficient (A) | −1.9961E−03 | −1.2404E−03 | 2.5564E−03 | −1.3392E−03 | −4.8831E−04 |
| Sixth Coefficient (B) | −1.6621E−04 | 5.9728E−04 | 2.4832E−04 | −5.7794E−04 | −5.0739E−04 |
| Eighth Coefficient (C) | 3.0601E−05 | 1.3467E−04 | 2.3507E−04 | −3.5712E−07 | 1.1780E−06 |

Additionally, the optical imaging system configured as described above may have the aberration characteristics illustrated in FIG. 12.

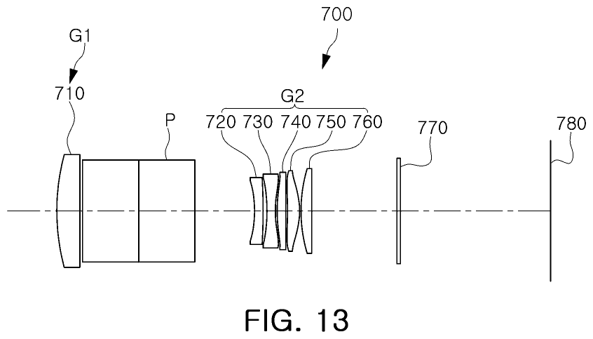

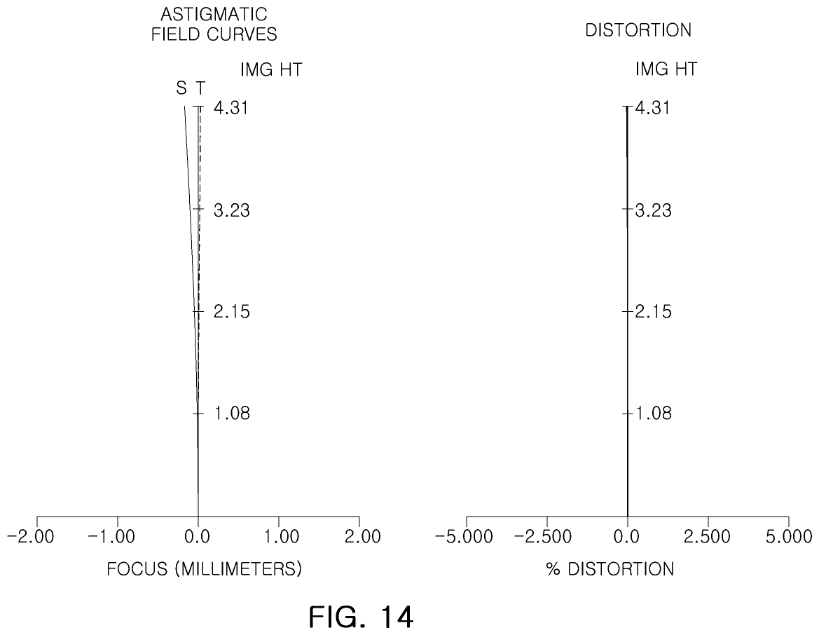

An example optical imaging system 700 according to a seventh embodiment will be described with reference to FIGS. 13 and 14.

The example optical imaging system 700 according to the seventh embodiment includes a first lens group G1, a reflective member P, and a second lens group G2.

The first lens group G1 includes a first lens 710, and the second lens group G2 includes a second lens 720, a third lens 730, a fourth lens 740, a fifth lens 750, and a sixth lens 760.

Additionally, the example optical imaging system 700 may further include a filter 770 and an image sensor.

The example optical imaging system 700 according to the seventh embodiment may form a focus on an imaging surface 780. The imaging surface 780 may refer to a surface on which a focus is formed by the example optical imaging system. In an example, the imaging surface 780 may refer to one surface of the image sensor on which light is received.

The reflective member P is disposed between the first lens 710 and the second lens 720 and may have a reflective surface that changes the optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 13 below.

TABLE 13

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second Lens | −7.984 | 0.507 | 1.546 | 56.0 | −17.9625 |
| S7 | | −43.800 | 0.223 | | | |
| S8 | Third Lens | −10.807 | 0.500 | 1.646 | 23.5 | −7.3310 |
| S9 | | 8.572 | 0.100 | | | |
| S10 | Fourth Lens | 10.295 | 0.500 | 1.668 | 20.4 | 17.3219 |
| S11 | | 91.203 | 0.100 | | | |
| S12 | Fifth Lens | −28.299 | 0.700 | 1.537 | 55.7 | 12.1861 |
| S13 | | −5.362 | 0.100 | | | |
| S14 | Sixth Lens | 10.018 | 0.629 | 1.537 | 55.7 | 16.0142 |
| S15 | | −59.503 | 5.000 | | | |
| S16 | Filter | Infinity | 0.210 | 1.519 | 64.2 | |
| S17 | | Infinity | 8.810 | | | |
| S18 | Imaging | Infinity | | | | |
| | Surface | | | | | |

In an example, the total focal length f of the example optical imaging system 700 according to the seventh embodiment is 18 mm, and the focal length fG2 of the second lens group G2 is 24.7176 mm.

In the seventh embodiment, the first lens 710 has positive refractive power, a first surface of the first lens 710 is convex, and a second surface of the first lens 710 is concave.

The second lens 720 has negative refractive power, a first surface of the second lens 720 is concave, and a second surface of the second lens 720 is convex.

The third lens 730 has negative refractive power, and first and second surfaces of the third lens 730 are concave.

The fourth lens 740 has positive refractive power, a first surface of the fourth lens 740 is convex, and a second surface of the fourth lens 740 is concave.

The fifth lens 750 has positive refractive power, a first surface of the fifth lens 750 is concave, and a second surface of the fifth lens 750 is convex.

The sixth lens 760 has positive refractive power, and first and second surfaces of the sixth lens 760 are convex.

In an example, each surface of the second lens 720 to the sixth lens 760 has an aspherical coefficient as illustrated in Table 14 below. In an example, the object-side surfaces and the image-side surfaces of the second lens 720 to the sixth lens 760 are aspherical.

TABLE 14

| | S6 | S7 | S8 | S9 | S10 |
|---|---|---|---|---|---|
| Conic Constant (K) | 0.000 | 0.000 | 0.000 | 0.000 | 0.000 |
| Fourth Coefficient (A) | −2.6605E−03 | −1.4459E−04 | −3.8923E−04 | −1.5066E−03 | −8.7359E−05 |
| Sixth Coefficient (B) | −1.3576E−04 | −5.7687E−05 | −1.8681E−04 | −4.6356E−04 | −1.7613E−04 |
| Eighth Coefficient (C) | 3.0936E−05 | −1.2644E−05 | −6.1120E−06 | −9.3565E−05 | −1.0278E−04 |

| | S11 | S12 | S13 | S14 | S15 |
|---|---|---|---|---|---|
| Conic Constant (K) | 0.000 | 0.000 | 0.000 | 0.000 | 0.000 |
| Fourth Coefficient (A) | −4.2326E−04 | 2.1989E−03 | 7.4515E−04 | 4.8988E−04 | 1.5027E−03 |
| Sixth Coefficient (B) | −2.0886E−05 | 2.7652E−04 | 3.5827E−04 | −1.4886E−06 | −6.4569E−05 |
| Eighth Coefficient (C) | −6.5113E−06 | 3.1881E−05 | 6.2120E−05 | −3.4836E−06 | 2.7957E−06 |

Additionally, the example optical imaging system configured as described above may have the aberration characteristics illustrated in FIG. 14.

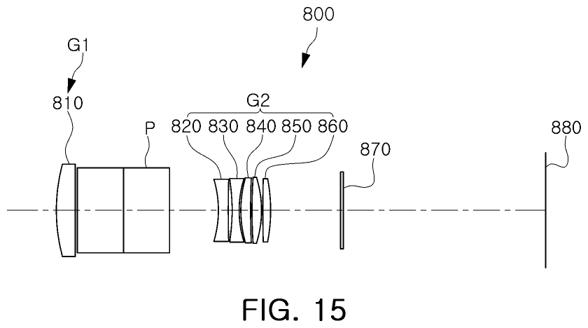

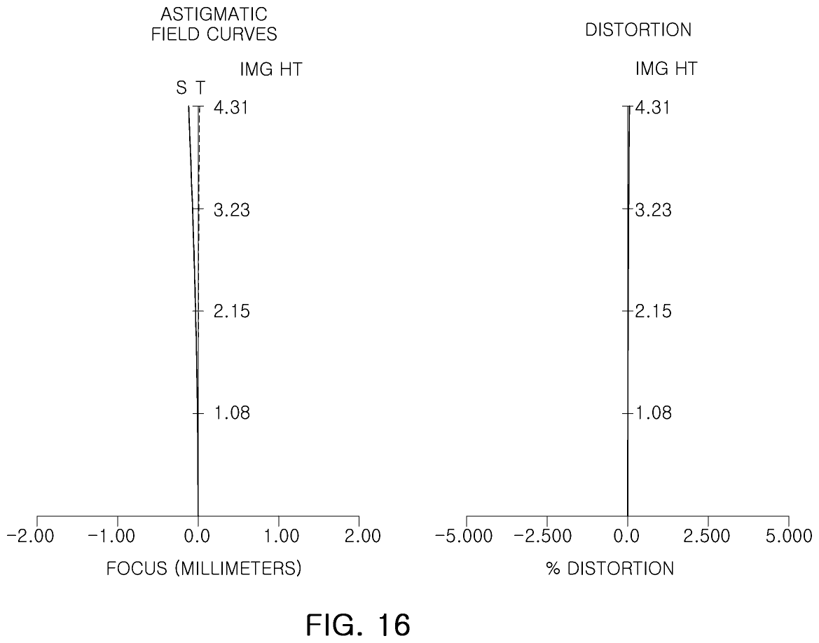

An example optical imaging system 800 according to an eighth embodiment will be described with reference to FIGS. 15 and 16.

The example optical imaging system 800 according to the eighth embodiment includes a first lens group G1, a reflective member P, and a second lens group G2.

The first lens group G1 includes a first lens 810, and the second lens group G2 includes a second lens 820, a third lens 830, a fourth lens 840, a fifth lens 850, and a sixth lens 860.

Additionally, the example optical imaging system 800 may further include a filter 870 and an image sensor.

The example optical imaging system 800 according to the eighth embodiment may form a focus on an imaging surface 880. The imaging surface 880 may refer to a surface on which a focus is formed by the optical imaging system. In an example, the imaging surface 880 may refer to one surface of the image sensor on which light is received.

The reflective member P may be disposed between the first lens 810 and the second lens 820 and may have a reflective surface that changes an optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 15 below.

TABLE 15

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | −9.006 | 0.700 | 1.546 | 56.0 | −14.7596 |
| | Lens | | | | | |
| S7 | | 79.202 | 0.280 | | | |
| S8 | Third Lens | −15.086 | 0.500 | 1.646 | 23.5 | −7.9944 |
| S9 | | 7.946 | 0.123 | | | |
| S10 | Fourth Lens | 8.960 | 0.700 | 1.668 | 20.4 | 15.4510 |
| S11 | | 65.569 | 0.100 | | | |
| S12 | Fifth Lens | 40.423 | 0.680 | 1.537 | 55.7 | 13.2883 |
| S13 | | −8.617 | 0.100 | | | |
| S14 | Sixth Lens | 157.992 | 0.551 | 1.537 | 55.7 | 22.1507 |
| S15 | | −12.851 | 5.000 | | | |
| S16 | Filter | Infinity | 0.210 | 1.519 | 64.2 | |
| S17 | | Infinity | 14.478 | | | |
| S18 | Imaging | Infinity | | | | |
| | Surface | | | | | |

In an example, the total focal length f of the optical imaging system according to the eighth embodiment is 25 mm, and the focal length fG2 of the second lens group G2 is 57.0040 mm.

In the eighth embodiment, the first lens 810 has positive refractive power, a first surface of the first lens 810 is convex, and a second surface of the first lens 810 is concave.

The second lens 820 has negative refractive power, and first and second surfaces of the second lens 820 are concave.

The third lens 830 has negative refractive power, and first and second surfaces of the third lens 830 are concave.

The fourth lens 840 has positive refractive power, a first surface of the fourth lens 840 is convex, and a second surface of the fourth lens 840 is concave.

The fifth lens 850 has positive refractive power, and first and second surfaces of the fifth lens 850 are convex.

The sixth lens 860 has positive refractive power, and first and second surfaces of the sixth lens 860 are convex.

In an example, each surface of the second lens 820 to the sixth lens 860 has an aspherical coefficient as illustrated in Table 16 below. For example, the object-side surfaces and the image-side surfaces of the second lens 820 to the sixth lens 860 are aspherical.

TABLE 16

| | S6 | S7 | S8 | S9 | S10 |
|---|---|---|---|---|---|
| Conic Constant (K) | 2.075 | −95.582 | −0.560 | −0.221 | 0.388 |
| Fourth Coefficient (A) | −1.0398E−04 | −3.2905E−05 | 7.8645E−05 | −8.4411E−05 | −2.7307E−05 |
| Sixth Coefficient (B) | −1.1832E−05 | −5.7805E−06 | 2.3164E−05 | −2.2147E−05 | −9.4968E−06 |
| Eighth Coefficient (C) | −1.7152E−06 | 3.2954E−07 | 6.6267E−06 | −3.5759E−06 | −3.6674E−06 |

| | S11 | S12 | S13 | S14 | S15 |
|---|---|---|---|---|---|
| Conic Constant (K) | 99.000 | 67.695 | 0.073 | −81.673 | −0.049 |
| Fourth Coefficient (A) | 3.1987E−05 | 5.3520E−05 | 1.9937E−05 | 3.2949E−05 | 8.5163E−05 |
| Sixth Coefficient (B) | 8.5929E−06 | 2.3006E−06 | 1.2574E−05 | 6.1065E−06 | 9.0587E−06 |
| Eighth Coefficient (C) | 1.9016E−06 | −1.4007E−06 | 1.7722E−06 | 1.5415E−06 | −1.0911E−06 |

Additionally, the example optical imaging system configured as described above may have the aberration characteristics illustrated in FIG. 16.

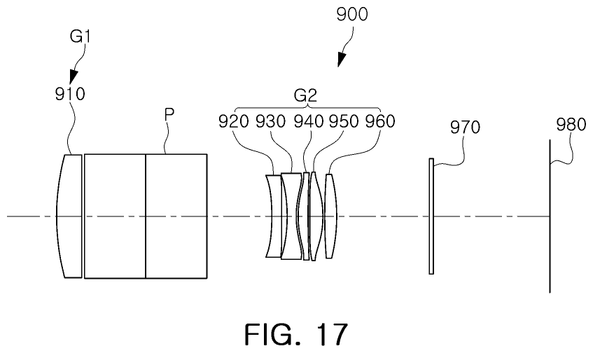

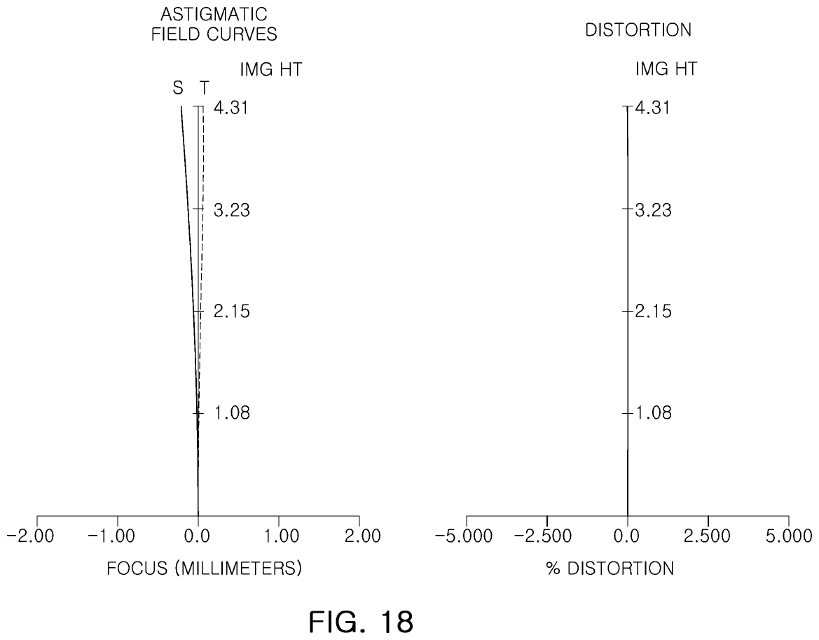

An example optical imaging system 900 according to a ninth embodiment will be described with reference to FIGS. 17 and 18.

The example optical imaging system 900 according to the ninth embodiment includes a first lens group G1, a reflective member P, and a second lens group G2.

The first lens group G1 includes a first lens 910, and the second lens group G2 includes a second lens 920, a third lens 930, a fourth lens 940, a fifth lens 950, and a sixth lens 960.

Additionally, the example optical imaging system 900 may further include a filter 970 and an image sensor.

The example optical imaging system 900 according to the ninth embodiment may form a focus on an imaging surface 980. The imaging surface 980 may refer to a surface on which a focus is formed by the optical imaging system. In an example, the imaging surface 980 may refer to one surface of an image sensor on which light is received.

The reflective member P may be disposed between the first lens 910 and the second lens 920 and may have a reflective surface that changes the optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 17 below.

TABLE 17

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.498 | 81.6 | 28.0871 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | −17.486 | 0.532 | 1.546 | 56.0 | −28.3578 |
| | Lens | | | | | |
| S7 | | 137.387 | 0.300 | | | |
| S8 | Third Lens | −9.918 | 0.500 | 1.646 | 23.5 | −5.3070 |
| S9 | | 5.337 | 0.109 | | | |
| S10 | Fourth Lens | 6.456 | 0.518 | 1.668 | 20.4 | 11.5188 |
| S11 | | 38.732 | 0.100 | | | |
| S12 | Fifth Lens | 177.612 | 0.700 | 1.537 | 55.7 | 10.2368 |
| S13 | | −5.666 | 0.100 | | | |
| S14 | Sixth Lens | 84.731 | 0.644 | 1.537 | 55.7 | 15.2391 |
| S15 | | −9.037 | 5.000 | | | |
| S16 | Filter | Infinity | 0.210 | 1.519 | 64.2 | |
| S17 | | Infinity | 6.287 | | | |
| S18 | Imaging | Infinity | | | | |
| | Surface | | | | | |

In an example, the total focal length f of the optical imaging system 900 according to the ninth embodiment is 15 mm, and the focal length fG2 of the second lens group G2 is 17.2725 mm.

In the ninth embodiment, the first lens 910 has positive refractive power, a first surface of the first lens 910 is convex, and a second surface of the first lens 910 is concave.

The second lens 920 has a negative refractive power, and first and second surfaces of the second lens 920 are concave.

The third lens 930 has negative refractive power, and first and second surfaces of the third lens 930 are concave.

The fourth lens 940 has positive refractive power, a first surface of the fourth lens 940 is convex, and a second surface of the fourth lens 940 is concave.

The fifth lens 950 has positive refractive power, and first and second surfaces of the fifth lens 950 are convex.

The sixth lens 960 has positive refractive power, and first and second surfaces of the sixth lens 960 are convex.

In an example, each surface of the second lens 920 to the sixth lens 960 has an aspherical coefficient as illustrated in Table 18 below. In an example, the object-side surfaces and the image-side surfaces of the second lens 920 to the sixth lens 960 are aspherical.

TABLE 18

| | S6 | S7 | S8 | S9 | S10 |
|---|---|---|---|---|---|
| Conic Constant (K) | 24.028 | −99.000 | 7.896 | −4.178 | −2.467 |
| Fourth Coefficient (A) | −3.6780E−03 | −1.1247E−04 | −4.0542E−04 | −1.4097E−03 | −6.3031E−04 |
| Sixth Coefficient (B) | −3.9129E−04 | −3.1421E−04 | 1.3523E−04 | −3.7470E−04 | −2.2824E−04 |
| Eighth Coefficient (C) | 3.5072E−05 | −1.8661E−05 | −2.2348E−05 | −8.8382E−05 | −6.2469E−05 |

| | S11 | S12 | S13 | S14 | S15 |
|---|---|---|---|---|---|
| Conic Constant (K) | −99.000 | 99.000 | −0.212 | −99.000 | −2.661 |
| 4 Fourth Coefficient (A) | −2.5015E−04 | 9.7804E−04 | −7.0584E−05 | 1.0952E−03 | 7.2756E−04 |
| Sixth Coefficient (B) | −9.5959E−06 | 1.3016E−04 | 2.5901E−04 | 9.2931E−05 | −4.1812E−06 |
| Eighth Coefficient (C) | −5.5754E−07 | 1.8966E−05 | 6.5875E−05 | −1.6410E−06 | 2.4536E−06 |

Additionally, the example optical imaging system configured as described above may have the aberration characteristics illustrated in FIG. 18.

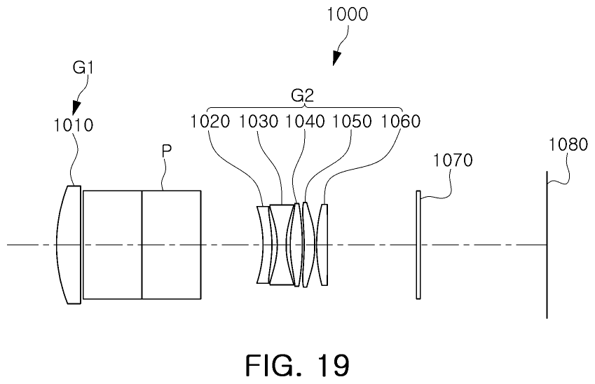

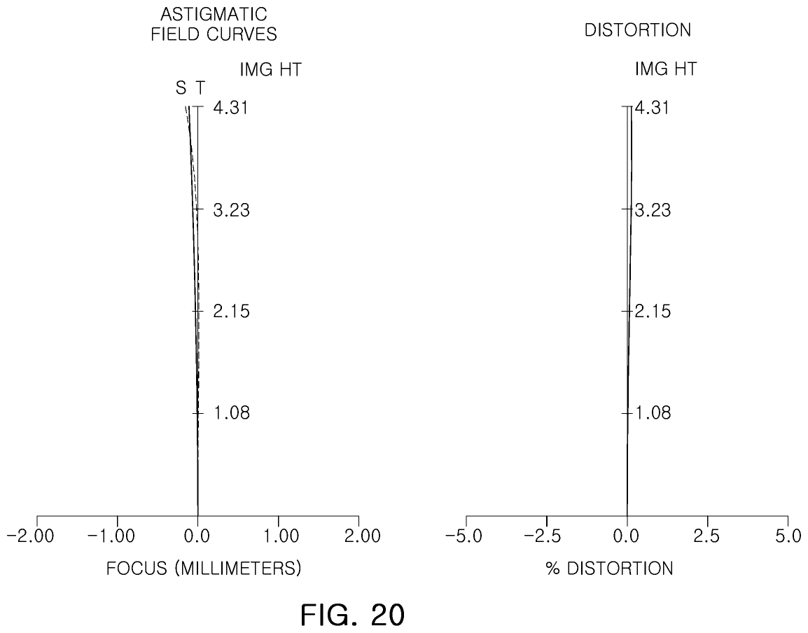

An example optical imaging system 1000 according to a tenth embodiment will be described with reference to FIGS. 19 and 20.

The example optical imaging system 1000 according to the tenth embodiment includes a first lens group G1, a reflective member P, and a second lens group G2.

The first lens group G1 includes a first lens 1010, and the second lens group G2 includes a second lens 1020, a third lens 1030, a fourth lens 1040, a fifth lens 1050, and a sixth lens 1060.

Additionally, the example optical imaging system 1000 may further include a filter 1070 and an image sensor.

The optical imaging system 1000 according to the tenth embodiment may form a focus on an imaging surface 1080. The imaging surface 1080 may refer to a surface on which a focus is formed by the optical imaging system. In an example, the imaging surface 1080 may refer to one surface of the image sensor on which light is received.

The reflective member P may be disposed between the first lens 1010 and the second lens 1020 and may have a reflective surface that changes the optical path. In an example reflective member P may be a prism, but may be provided as a mirror.

The lens characteristics of each lens (a radius of curvature, a thickness of the lens, a distance between the lenses, an index of refraction, an Abbe number, and a focal length) are illustrated in Table 19 below.

TABLE 19

| | | | Thickness | | | |
|---|---|---|---|---|---|---|
| Surface | | | or | | Abbe | Focal |
| Number | Division | Radius | Distance | Index | Number | Length |
| S1 | First Lens | 14.000 | 1.350 | 1.489 | 70.4 | 20.4440 |
| S2 | | Infinity | 0.150 | | | |
| S3 | Reflective | Infinity | 3.300 | 1.839 | 37.3 | |
| | Member | | | | | |
| S4 | | Infinity | 3.300 | 1.839 | 37.3 | |
| S5 | | Infinity | 3.500 | | | |
| S6 | Second | −8.142 | 0.500 | 1.546 | 56.0 | 347.0066 |
| | Lens | | | | | |
| S7 | | −7.976 | 0.300 | | | |
| S8 | Third | −4.786 | 0.500 | 1.646 | 23.5 | −3.6532 |
| | Lens | | | | | |
| S9 | | 4.840 | 0.240 | | | |
| S10 | Fourth | 9.120 | 0.667 | 1.668 | 20.4 | 8.0169 |
| | Lens | | | | | |
| S11 | | −12.608 | 0.100 | | | |
| S12 | Fifth Lens | −16.272 | 0.603 | 1.537 | 55.7 | 15.0000 |
| S13 | | −5.459 | 0.100 | | | |
| S14 | Sixth Lens | 10.232 | 0.615 | 1.537 | 55.7 | 17.8774 |
| S15 | | −152.960 | 5.000 | | | |
| S16 | Filter | Infinity | 0.210 | 1.519 | 64.2 | |
| S17 | | Infinity | 7.115 | | | |
| S18 | Imaging | Infinity | | | | |
| | Surface | | | | | |

In an example, the total focal length f of the example optical imaging system 1000 according to the tenth embodiment is 19 mm, and the focal length fG2 of the second lens group G2 is 34.9296 mm.

In the tenth embodiment, the first lens 1010 has positive refractive power, a first surface of the first lens 1010 is convex, and a second surface of the first lens 1010 is concave.

The second lens 1020 has positive refractive power, a first surface of the second lens 1020 is concave, and a second surface of the second lens 1020 is convex.

The third lens 1030 has negative refractive power, and first and second surfaces of the third lens 1030 are concave.

The fourth lens 1040 has positive refractive power, and first and second surfaces of the fourth lens 1040 are convex.

The fifth lens 1050 has positive refractive power, first surface of the fifth lens 1050 is concave, and a second surface of the fifth lens 1050 is convex.

The sixth lens 1060 has positive refractive power, and first and second surfaces of the sixth lens 1060 are convex.

In an example, each surface of the second lens 1020 to the sixth lens 1060 has an aspherical coefficient as illustrated in Table 20 below. For example, the object-side surfaces and the image-side surfaces of the second lens 1020 to the sixth lens 1060 are aspherical.

TABLE 20

| | S6 | S7 | S8 | S9 | S10 |
|---|---|---|---|---|---|
| Conic Constant (K) | 6.234 | −9.006 | −2.691 | −4.259 | −1.896 |
| Fourth Coefficient (A) | −1.6740E−03 | 7.0716E−04 | 1.0122E−03 | −1.5528E−03 | −1.1884E−04 |
| Sixth Coefficient (B) | 4.4498E−04 | 2.9507E−04 | 1.1675E−04 | −6.2889E−05 | −1.2734E−04 |
| Eighth Coefficient (C) | 1.9934E−05 | 6.7539E−05 | 5.1561E−05 | −1.1746E−06 | −3.4772E−05 |
| | S11 | S12 | S13 | S14 | S15 |
| Conic Constant (K) | 2.695 | −41.126 | −1.941 | 3.211 | 99.000 |
| Fourth Coefficient (A) | 1.0351E−03 | 6.9543E−04 | 7.4771E−04 | −4.8003E−04 | −5.0145E−04 |
| Sixth Coefficient (B) | 1.2992E−04 | 1.6262E−04 | 1.6801E−04 | 3.1209E−05 | −2.2429E−05 |
| Eighth Coefficient (C) | −1.6177E−05 | 3.8035E−05 | 1.2833E−05 | 1.0019E−05 | 2.1513E−05 |

Additionally, the optical imaging system configured as described above may have the aberration characteristics illustrated in FIG. 20.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An optical imaging system, comprising:
a first lens group, a reflective member, and a second lens group arranged sequentially along an optical axis,
wherein the first lens group comprises one lens, and the second lens group comprises two or more lenses,
wherein the first lens group has positive refractive power, and the second lens group has positive refractive power as a whole,
wherein an effective diameter of the lens included in the first lens group is greater than an effective diameter of the lenses included in the second lens group, and
wherein 0<D1/f<0.05 is satisfied, where D1 is a distance on the optical axis between an image-side surface of the lens included in the first lens group and the reflective member, and f is a total focal length of the optical imaging system.

2. The optical imaging system of claim 1, wherein TTL/f>1 is satisfied, where TTL is a distance on the optical axis from an object-side surface of the lens included in the first lens group to an imaging surface.

3. The optical imaging system of claim 2, wherein 1.5<TTL/BFL<3.5 is satisfied, where BFL is a distance on the optical axis from an image-side surface of a rearmost lens among the lenses included in the second lens group to the imaging surface.

4. The optical imaging system of claim 1, wherein the first lens group comprises a first lens, and the second lens group comprises a second lens, a third lens, a fourth lens, and a fifth lens, and
v1>50 is satisfied, where v1 is an Abbe number of the first lens.

5. The optical imaging system of claim 4, wherein an Abbe number of the second lens is less than an Abbe number of the first lens.

6. The optical imaging system of claim 5, wherein 10<v1−v2<60 is satisfied, where v2 is an Abbe number of the second lens.

7. The optical imaging system of claim 4, wherein 0.2<f/f1<1 is satisfied, where f1 is a focal length of the first lens.

8. The optical imaging system of claim 4, wherein 1.5<|f2/f3|<100 is satisfied, where f2 is a focal length of the second lens, and f3 is a focal length of the third lens.

9. The optical imaging system of claim 4, wherein −65<fG2/f3<−3 is satisfied, where fG2 is a focal length of the second lens group, and f3 is a focal length of the third lens.

10. The optical imaging system of claim 1, wherein 0<fG1/fG2<3 is satisfied, where fG1 is a focal length of the first lens group, and fG2 is a focal length of the second lens group.

11. The optical imaging system of claim 1, wherein among the lenses included in the second lens group, one or more lenses has negative refractive power and has a concave object side and a concave image side.

12. The optical imaging system of claim 11, wherein among the lenses included in the second lens group, when two or more lenses have negative refractive power and are concave on both sides, a lens with a smallest absolute value of a focal length among the lenses on which both sides are concave has a refractive index of 1.62 or more, and an Abbe number of less than 26.

13. The optical imaging system of claim 1, wherein the second lens group comprises a second lens, a third lens, a fourth lens, and a fifth lens, and
the first lens has positive refractive power, the second lens has positive refractive power, and the third lens has negative refractive power.

14. The optical imaging system of claim 1, wherein the first lens group comprises a first lens, and the second lens group comprises a second lens, a third lens, a fourth lens, a fifth lens, and a sixth lens, and
the first lens has positive refractive power, the third lens has negative refractive power, and the fourth lens has positive refractive power.

15. A portable electronic device, comprising:
a camera module comprising:
the optical imaging system of claim 1,
wherein the optical imaging system further comprises an image sensor configured to convert an image of an incident subject into an electrical signal.

16. An optical imaging system, comprising:
a first lens group, a reflective member, and a second lens group arranged sequentially along an optical axis,
wherein the second lens group comprises four to five lenses,
wherein the first lens group has positive refractive power,
wherein a first lens of the first lens group has a concave image-side surface,
wherein a second lens of the second lens group has negative refractive power, and
wherein an effective diameter of the first lens included in the first lens group is greater than an effective diameter of the lenses included in the second lens group.
